(19) United States
(12) Patent Application Publication
(10) Pub. No.: US 2006/0273676 A1
(43) Pub. Date: Dec. 7, 2006

(54) Axial gap motor

(75) Inventors: Yuji Naruse, Zushi-shi (JP); Yuusuke Minagawa, Yokosuka-shi (JP); Yutaro Kaneko, Yokohama-shi (JP); Tadayuki Hatsuda, Fujisawa-shi (JP)

Correspondence Address: SHUMAKER & SIEFFERT, P. A., 8425 SEASONS PARKWAY, SUITE 105, ST. PAUL, MN, 55125, US

(73) Assignee: Nissan Motor Co., Ltd., Yokohama-shi (JP)

(21) Appl. No.: 11/435,309

(22) Filed: May 16, 2006

(30) Foreign Application Priority Data
May 17, 2005 (JP) 2005-143358
Feb. 27, 2006 (JP) 2006-049828

(51) Int. Cl. H02K 21/12; H02K 1/22

(52) U.S. Cl. 310/156.32; 310/268

(57) ABSTRACT

An axial gap motor may benefit from a reduction of axial force on the rotor, which may reduce load on the rotor and bearings and reduce the vibration on the surface of the rotor. An air gap is positioned on the stator facing the rotor, and an auxiliary yoke is positioned facing the air gap on the other side of the rotor. Magnetic flux circulates from the rotor and the axial force α is applied to the rotor when the magnetic flux passes by the air gap surface on the stator side of the rotor. Axial force β is applied to the rotor when the magnetic flux passes by the air gap surface on the auxiliary yoke side of the rotor. Axial force β is opposite, or reverse, of axial force α and reduces axial force α so axial force α reduces the load on the rotor and bearings.

This application claims priority to Japanese Patent Application No. 2005-143358, filed May 17, 2005, and Japanese Patent Application No. 2006-049828, Feb. 27, 2006, the entire content of each is incorporated herein by reference.

### TECHNICAL FIELD

The invention relates to axial gap motors.

### BACKGROUND

A synchronized motor using a permanent magnet in the rotor of the motor generates magnetic torque by attracting and repelling a permanent magnet inside the rotor via a rotating magnetic field generated through electricity from the stator. This magnetic torque rotates the rotor, which in turn operates the motor.

A type of synchronized motor is an axial gap motor. The axial gap motor includes the rotor and stator which are housed in a case positioned in a direction facing the rotor rotary shaft. An axial gap motor has a disc shaped rotor and stator that are positioned in a direction facing the rotor rotary shaft.

### SUMMARY

In general, the invention relates to axial gap motors that include a structure that reduces or offsets the axial force on the rotor generated when magnetic flux passes the gap surface of the rotor. In this manner, load on the rotor and bearings may be reduced. Vibration on the rotor surface may also be reduced.

In motors, magnetic flux generated via electricity to the stator and magnetic flux generated via a permanent magnet inside a rotor function as magnetic flux to generate torque that passes through the surface facing the rotor and stator, which is an air gap surface. When this magnetic flux passes the air gap surface, the magnetic flux also adds force to the rotor in a direction that does not contribute to the torque of the motor.

With the axial gap motor, the surfaces facing the rotor and stator that form the air gap are level and intersect the rotor rotary shaft. Magnetic flux in the space between the air gap and rotor does not produce a force that contributes to the output torque of the motor. Instead, the magnetic flux functions as an axial force in the direction of the rotary shaft on the rotor.

The magnetic flux that generates torque is generated when passing the surface of the rotor, i.e. gap surface, facing the stator. The axial force in the direction of the rotary shaft on the rotor becomes a force that is only directed in the direction of the rotor to the stator. The axial force from the rotor in the direction facing the stator increases the load on the rotor and bearings. This force may be large in a field where weak magnetic flux control is not conducted the force cannot be avoided.

The present invention has the objective of resolving these issues with an axial gap motor with an improved structure that reduces or offsets the axial force on the rotor generated when magnetic flux passes the gap surface of the rotor.

In one embodiment, the invention is directed to an axial gap motor that includes a rotary shaft that rotates freely within a case, a rotor comprising a plurality of permanent magnets connected to the rotary shaft, and a stator comprising a plurality of coils positioned facing a first side of the rotor, wherein the stator is disposed on the same axis as the rotary shaft. The axial gap motor also includes an auxiliary yoke disposed inside the case and positioned facing a second side of the rotor on the same axis as the rotary shaft. The auxiliary yoke cannot be displaced in an axial direction, and the auxiliary yoke comprises a magnetic body.

In another embodiment, the invention is directed to a method that includes rotating a rotor between a stator and an auxiliary yoke, wherein the rotor is attached to a freely rotating rotary shaft and the stator and auxiliary yoke are fixed within the case. The method also includes generating torque at the rotary shaft via a magnetic flux between the rotor, stator, and auxiliary yoke.

In another embodiment, the invention is directed to an axial gap motor that includes means for rotating a rotor freely within a case, means for generating torque via a magnetic flux, and means for reducing an axial force between the generating means.

With the axial gap motor in the present invention, most, if not all, of the magnetic flux that generates torque can be directed to the auxiliary yoke positioned on the side of the rotor facing the position of the stator. As a result, the magnetic flux also passes the rotor surface on the side of the rotor facing the position of the stator.

The axial force generated when the magnetic flux passes by the rotor surface on the side of the rotor facing the position of the stator is opposite of the axial force generated when the magnetic flux passes by the rotor surface facing the stator. These axial forces are reduced or offset by the rotor. Therefore, the axial force generated when the magnetic flux passes by the rotor surface facing the stator may reduce load on the rotor and bearings, as well as vibration generated on the rotor surface.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a conceptual cross-section showing one embodiment of a prior art axial gap motor that demonstrates the problems that are solved by the present invention.

FIG. 2 is a conceptual side view drawing showing the magnetic flux flow from the prior art axial gap motor shown in FIG. 1, where the flux bypasses the stator or the rotor.

FIG. 3 is a conceptual side view drawing showing the magnetic flux flow from the axial gap motor bypassing only the essential parts.

FIG. 4 is a front view showing the rotor in the axial gap motor from the same embodiment, from the perspective of arrow A in FIG. 3.

FIG. 5 is a front view showing the stator in the axial gap motor from the same embodiment, from the perspective of arrow B in FIG. 3.

FIG. 6 is a front view showing the auxiliary yoke in the axial gap motor from the same embodiment, from the perspective of arrow C in FIG. 3.

FIG. 7 shows the magnetic flux distribution for the axial gap motor in the same embodiment, with (a) a magnetic flux distribution diagram when the auxiliary yoke from FIG. 6 does not have auxiliary yoke cores, and (b) a magnetic flux distribution diagram when the auxiliary yoke from FIG. 6 does have auxiliary yoke cores.

FIG. 8 is a conceptual cross-section of the essential elements of the axial gap motor, showing one example of the mounting structure relating to the auxiliary yoke from FIG. 3.

FIG. 9 is a conceptual cross-section of the essential elements of the axial gap motor, showing another example of the mounting structure relating to the auxiliary yoke from FIG. 3.

FIG. 10 is a conceptual cross-section of the essential elements of the axial gap motor, showing another example of the mounting structure relating to the auxiliary yoke from FIG. 3.

FIG. 11 is a front view that is similar to FIG. 6, except it is another embodiment of an auxiliary yoke different from that in FIG. 6.

FIG. 12 is a front view that is similar to FIG. 6, except it is another embodiment of an auxiliary yoke different from that in FIG. 6.

FIG. 13 shows changes over time in the axial force operating the rotor in the axial gap motor, with (a) a time chart showing the changes over time in the axial force operating the rotor in the axial gap motor that does not have an auxiliary yoke, as shown in FIGS. 1, 2; and (b) a time chart showing the changes over time in the axial force operating the rotor in the axial gap motor that does have an auxiliary yoke, as shown in FIGS. 3, 8-10.

### DETAILED DESCRIPTION

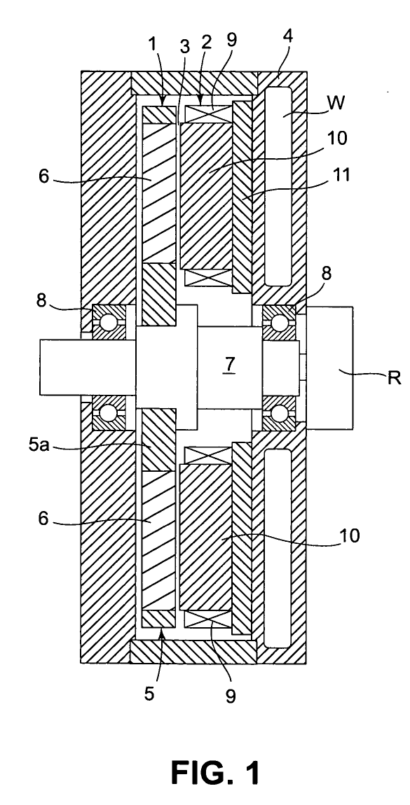

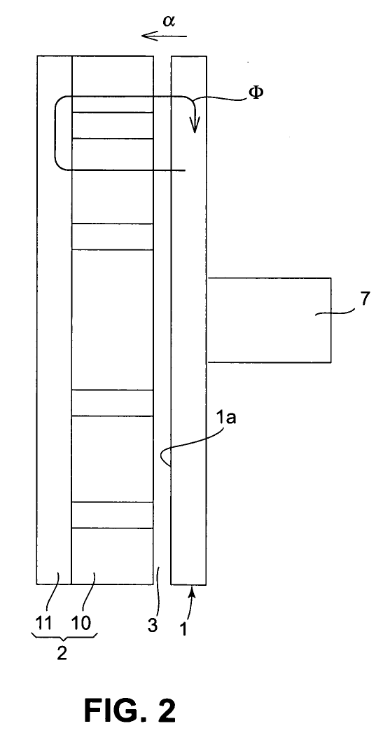

FIG. 1 is a conceptual cross-section of a prior art axial gap motor that produces unwanted axial force, undesirable load, and vibration. Both FIGS. 1 and 2 illustrate prior art axial gap motors for reference. In FIG. 1, rotor 1 and stator 2 are positioned facing the direction of the rotor rotary shaft in the gap, i.e. air gap 3, between the rotor and stator, wherein the rotor and stator are housed in a case 4. Rotor 1 and stator 2 may be a means for generating torque.

Rotor 1 is formed with a plurality of permanent magnets 6 facing a magnetic disc shaped rotor core 5 positioned in a circular direction. These permanent magnets 6 are positioned in a specific space where the polarity varies from that of the perimeter of the rotor core 5.

The rotor 1 is supported for free rotation within the case 4 to prevent displacement in the axial direction, i.e. the rotary shaft direction, via bearings 8 on both ends of the rotary shaft 7, i.e. a rotating means, where the center part 5a of the rotor core 5 is securely mounted. Stator 2 is formed of a stator core 10 wound around a magnetic coil 9 facing a plurality of back cores 11 positioned in a circular direction. The stator 2 is positioned at the center of the rotor 1 facing the rotor 1 with an air gap 3 formed by the stator core 10. Stator 2 is installed in the case 4 via the back core 11. W is the path for cool water that is cooled by the motor, while R is the rotary encoder that provides magnetic coil 9 sequential drive control signals detected by the rotor 1 rotational position.

The description of the operation of the axial gap motor shown in FIG. 1 is provided herein. Under the control of an inverter (not shown), the magnetic coil 9 is sequentially driven and magnetized to form a rotating magnetic field around the stator 2. The plurality of permanent magnets 6 positioned with varying polarities around the rotor 1 attract and repel the rotating magnetic field such that the rotor 1 revolves at a synchronized velocity around this rotating magnetic field.

The axial gap motor shown in FIG. 1 is also shown in FIG. 2, with only the relative relationship between the rotor 1 and the stator 2. FIG. 2 shows the positions of the rotor 1 and stator 2, wherein the rotor and stator are a mirror image of the rotor and stator illustrated in FIG. 1.

FIG. 2 illustrates the prior art axial gap motor and describes the channel for the magnetic flux Φ to generate torque. This magnetic flux Φ enters the stator 2 stator core 10 from the rotor 1 via the air gap 3. Then, it curves to return to the stator core 10 via the stator 2 back core 11 and passes by the air gap 3 from the stator core 10 to face the rotor 1. Again, the magnetic flux Φ enters the stator 2 from the rotor 1 via the air gap 3.

The magnetic flux Φ generating torque passes by the rotor 1 surface 1a, e.g. an air gap surface, facing the stator 2 to generate axial force α on the rotor 1 in the direction of the rotor rotary shaft. This axial force α is a force only in the direction from the rotor 1 to the stator 2, so the axial force α is integrated across the entire perimeter of rotor 1 so the force in one direction on the rotor 1 is perpetuated. Load on the bearing 8 (FIG. 1) supporting the rotor 1 and its free rotation, as well as the problem of rotor 1 surface vibration, may develop.

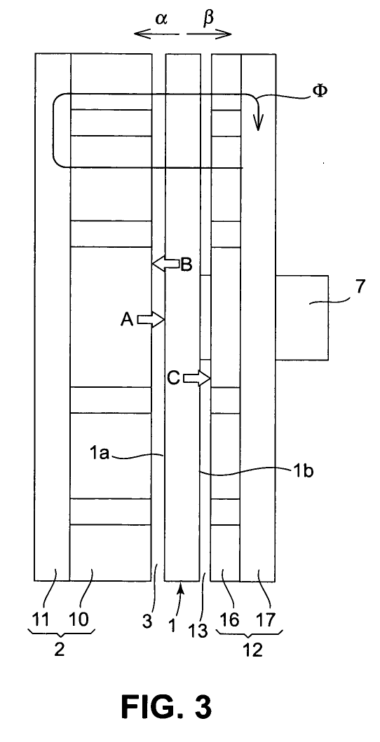

As shown in FIG. 3, auxiliary yoke 12, i.e. means for reducing axial force, that is a magnetic body added to the structure of that in FIG. 2, reduces axial force and vibration. This auxiliary yoke 12 is positioned concentric facing the rotor 1 on the side of the rotor where the stator 2 is positioned. There may be an air gap 13 that is identical to the air gap 3 in between the auxiliary yoke 12 and the rotor 1. Additionally, the auxiliary yoke 12 that maintains this air gap 13 is secured inside the case 4 (refer to FIG. 1) so the auxiliary yoke 12 cannot be displaced in the direction of the rotor rotary shaft. The diameter of the auxiliary yoke 12 should either be the same as the diameter of the rotor 1 or larger than it.

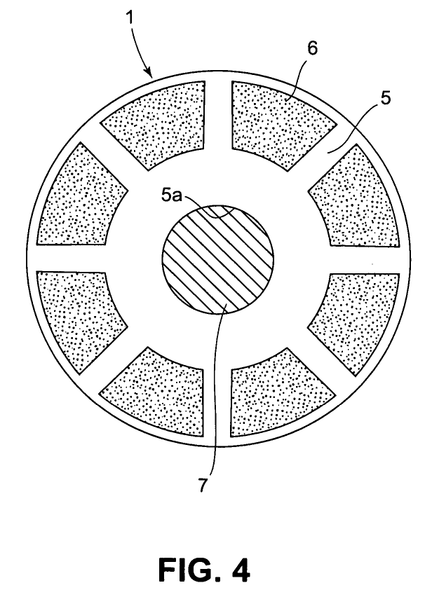

In this embodiment, rotor 1 is as shown in FIG. 4 with arrow A and is formed with a plurality of permanent magnets 6 facing a magnetic disc shaped rotor core 5 positioned in a circular direction. As indicated above, these permanent magnets 6 are arranged in the shape of a fan when viewed from the direction of the rotor rotary shaft for positioning in the space in a circular direction. They are embedded in the same shape as that formed in the rotor core 5 and positioned in a specific space where the polarity varies from that of the perimeter of the rotor core 5. Additionally, in the rotor 1, the center part 5a of the rotor core 5 is secured to the rotor rotary shaft.

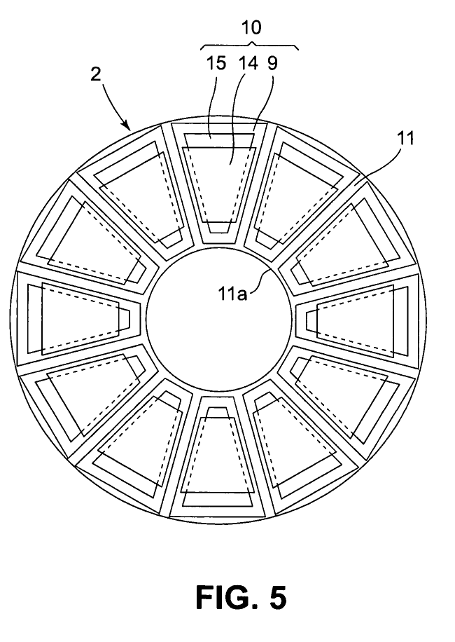

Additionally, as shown in FIG. 5 with arrow B of FIG. 3, the stator 2 is formed with stator cores 10 formed of an electromagnetic coil 9 wound around teeth 14 via insulation 15 that is positioned in the space around the periphery facing the magnetic disc shaped common stator back cores 11 for support.

As indicated above, the stator core 10 is positioned in the space around the periphery so is shaped like a fan when viewed from the direction of the rotor rotary shaft, and is set in a specific gap between adjacent stator cores 10. In the center of the stator back core 111 is a central opening 11a where the rotor rotary shaft 7 can be inserted.

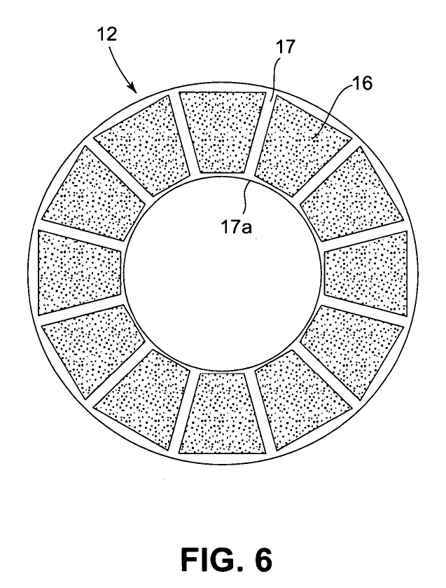

Furthermore, as shown in FIG. 6 with arrow C from FIG. 3, the auxiliary yoke 12 is formed with a plurality (ideally the same number as stator cores 10) of auxiliary yoke cores 16 positioned in a space that encircle the magnetic disc shaped common auxiliary yoke back cores 17 for support. In the center of the auxiliary yoke back core 17 is a central opening 17a where the rotor rotary shaft 7 can be inserted.

As shown in FIG. 3, the thickness of the auxiliary yoke back cores 17 in the axial direction is either the same as the thickness of the stator back cores 11 in the axial direction or thicker.

In the axial gap motor in this embodiment, the magnetic flux Φ to generate torque is as shown in FIG. 3, and enters the stator 2 stator core 10 from the rotor 1 via the air gap 3. Then, it curves to return to the stator core 10 via the stator 2 back core 111 and passes by the air gap 3 from the stator core 10 to face the rotor 1. Next it enters the auxiliary yoke 12 auxiliary yoke core 16 from the rotor 1 via the air gap 13 and then curves to return to the rotor 1 via the auxiliary yoke back core 17 and again enters the stator 2 from the rotor 1 via the air gap 3.

At this point, the magnetic flux Φ generating torque passes by the rotor 1 surface 1a (air gap surface) facing the stator 2 to generate axial force α on the rotor 1 in the direction of the rotor rotary shaft adjacent to the stator 1. On the other side, the magnetic flux Φ passes by the rotor 1 surface 1b (air gap surface) on the opposite side where the stator 2 is positioned. Thus, there is axial force β in the direction of the rotor rotary shaft as it passes on the rotor 1 away from the stator 1.

This axial force β is reverse that of the axial force α so the force required to integrate across the entire perimeter of rotor 1 reduces or offsets the axial force α required to integrate across the entire perimeter of rotor 1. Axial force α operates rotor 1 so the problem of an increased load on the bearing 8 (refer to FIG. 1) supporting the rotor 1 and its free rotation as well as the problem of rotor 1 surface vibration is reduced.

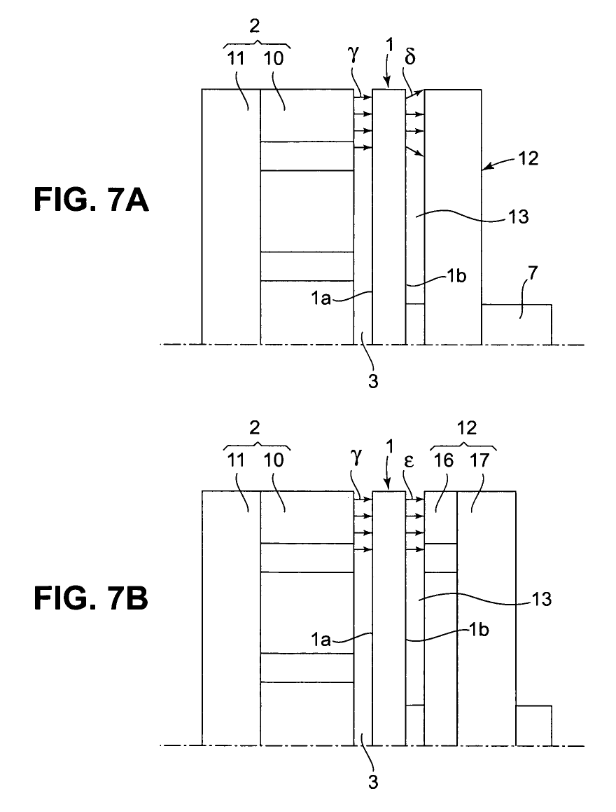

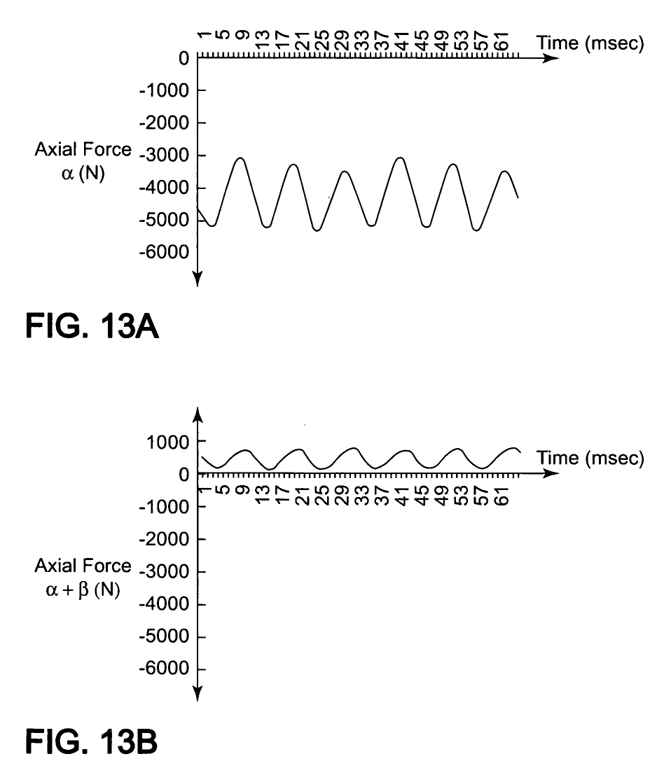

FIGS. 13A and 13B are graphs illustrating an addendum to the effects given above. FIG. 13A shows the changes over time, where time is in milliseconds (msec), in the axial force α, wherein units are Newtons (N), for a prior art axial gap motor that does not have the auxiliary yoke, as shown in FIG. 1 and FIG. 2. FIG. 13B shows the changes over time in the axial force α and β for the axial gap motor that is an embodiment equipped with the auxiliary yoke 12 as shown in FIG. 3. The negative of the axial force α or α and β in FIGS. 7A and B, respectively, shows the axial force in a direction where the rotor 1 contributes to stator 2.

As shown in FIG. 1 and FIG. 2, in the prior art axial gap motor that does not have the auxiliary yoke, the large axial force α is as shown in FIG. 13A. The axial gap motor that is an embodiment equipped with the auxiliary yoke 12 as shown in FIG. 3 can reduce the axial force α and β to nearly 1/10^{th} that of the prior art motor, as shown in FIG. 13B. In other words, axial force α may be less than 20 percent greater than axial force β. Alternatively, axial force β may be less than 20 percent greater than axial force α.

In the axial gap motor that is an embodiment equipped with the auxiliary yoke 12 as shown in FIG. 3, the axial force α and β is as shown in FIG. 13B, and has a positive direction. The magnetic flux between the rotor 1 and the auxiliary yoke 12 works on the rotor 1 and the value integrating the periphery of axial force β (refer to FIG. 3) is slightly larger than the value integrating the periphery of axial force α (refer to FIG. 3) due to the magnetic flux between the rotor 1 and the stator 2 that works on the rotor 1.

In this embodiment the auxiliary yoke 12 is as shown in FIG. 6 and is formed of a plurality of auxiliary yoke cores 16 that are arranged in the space in a circular direction around the magnetic disc shaped common auxiliary yoke back cores 17 for support. The following effect can be obtained.

FIG. 7A shows the structure when there are no auxiliary yoke cores 16 on the auxiliary yoke 12 as shown in FIG. 3 and FIG. 6. In this case, for the path of the magnetic flux from the stator 2 to the auxiliary yoke 12 via the rotor 1, the cross-section area of the auxiliary yoke 12 magnetic flux entry is greater than the cross-section area of the stator 2 magnetic flux exit (cross-section area of the right angle to the axis of the stator core 10). The magnetic flux distribution γ for the air gap 13 between the rotor 1 and the auxiliary yoke 12 is not symmetrical with the magnetic flux distribution δ for the air gap 13 between the rotor and the auxiliary yoke 12. The magnetic flux shown by δ leaks across the side of the auxiliary yoke 12 so the reduction in the axial force β prevents acquisition of a sufficient effect.

On the other hand, the auxiliary yoke 12 in this embodiment is as shown in FIG. 6 and is formed with a plurality of auxiliary yoke cores 16 arranged in the space in a circular direction around the auxiliary yoke back cores 17 for support.

As shown in FIG. 7B, in the path of the magnetic flux from the stator 2 to the auxiliary yoke 12 via the rotor 1, the cross-section area of the auxiliary yoke 12 magnetic flux entry (cross-section area of the right angle to the axis of the stator core 10) is the same as the cross-section area of the stator 2 magnetic flux exit (cross-section area of the right angle to the axis of the stator core 10). The magnetic flux distribution γ for the air gap 13 between the rotor 1 and the auxiliary yoke 12 is symmetrical with the magnetic flux distribution δ for the air gap 13 between the rotor and the auxiliary yoke 12. There are no leaks when the magnetic flux passes by the auxiliary yoke 12 so the axial force β is as expected, which confirms a sufficient effect.

As shown in FIG. 3, the thickness of the auxiliary yoke back core 17 in the direction of the axis in this embodiment is either the same as the thickness of the stator back core 11 in the direction of the axis or is thicker to exhibit the following effect. Basically, the number of magnetic flux lines determining the output of the motor is dependent on the minimum cross-section area of the magnetic flux path. The minimum cross-section area of the magnetic flux path for the motor rotor 2 and stator 2 is determined by the cross-section area of the direction of the magnetic flux path for the stator back core 11.

Thus, in this embodiment, if the thickness of the auxiliary yoke back core 17 in the axial direction is greater than the thickness of the stator back core 11 in the axial direction, the cross-section area of the magnetic flux path for the auxiliary yoke back core 17 will be greater than the cross-section area of the magnetic flux path for the stator back core 11. To exhibit the effect in this embodiment, the magnetic flux passes the auxiliary yoke 12, making it possible to achieve the effect by avoiding a reduction in motor output without reducing the number of magnetic flux lines.

As also indicated in this embodiment, since the diameter of the auxiliary yoke 12 is greater than the diameter of the rotor 1 magnetic flux leaks across the auxiliary yoke from the rotor 1 can be avoided. As a result, it is possible to confirm the effect with the axial force β (refer to FIG. 3) as expected to achieve the objective of the present invention.

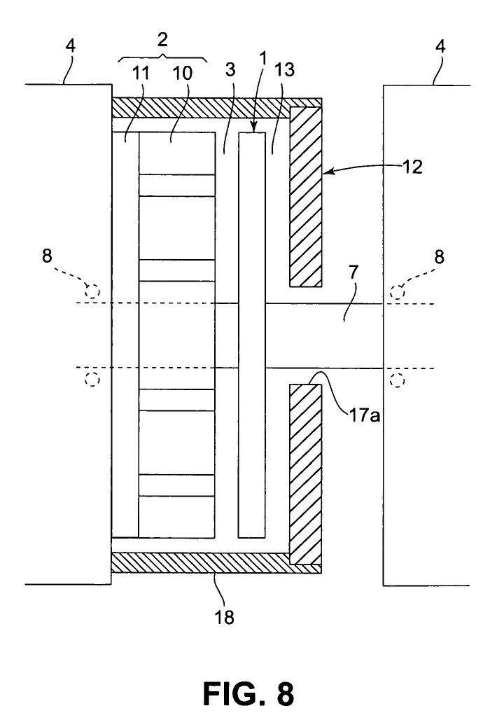

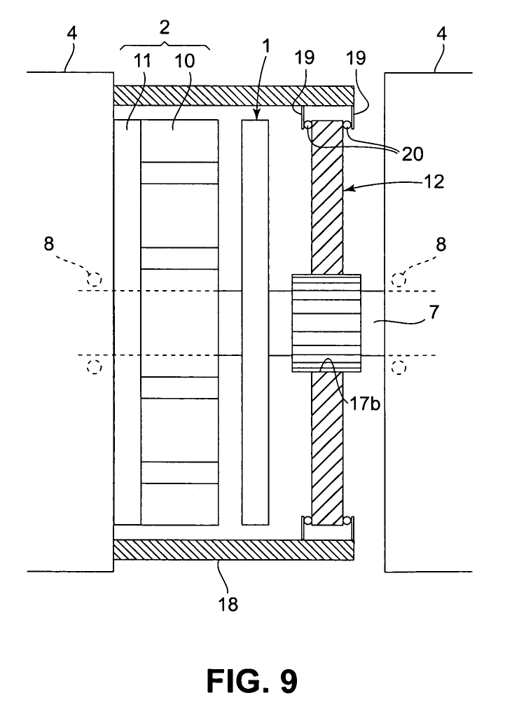

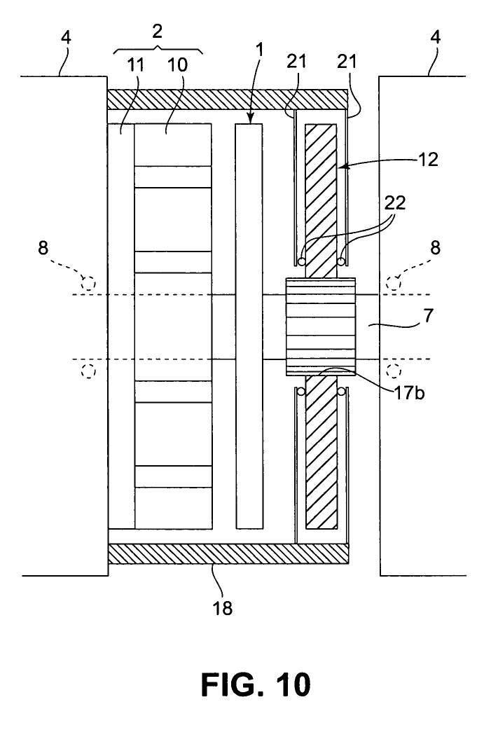

As indicated previously, the auxiliary yoke 12 is mounted in the case 4 so it will not be displaced in the direction of the rotor rotary shaft at all and when this is mounted, the structure shown in FIG. 8, FIG. 9 or FIG. 10 can be employed. First, in describing the mounting structure for the auxiliary yoke 12 shown in FIG. 8, there is a round auxiliary yoke support frame 18 holding the rotor 1 and the stator 2. The bottom is attached to the case 4 and the outside of the auxiliary yoke 12 is inserted into the end. The rotary shaft 7 of the rotor 1 penetrates both the stator 2 and the auxiliary yoke 12, and both ends of the axis support free rotation in the case 4 while each bearing 4 prevents displacement along the axis.

With the auxiliary yoke 12 mounting structure, the simple structure of the auxiliary yoke 12 enables mounting and prevents the auxiliary yoke 12 from rotating, which enhances the durability. Next, is a description of the auxiliary yoke 12 mounting structure shown in FIG. 9. There is a round auxiliary yoke support frame 18 holding the rotor 1 and the stator 2. The bottom is attached to the case 4.

The rotary shaft 7 of the rotor 1 penetrates both the stator 2 and the auxiliary yoke 12, and both ends of the axis support free rotation in the case 4 while each bearing 4 prevents displacement along the axis. Additionally, the center of the auxiliary yoke 12 fits into the spline 17b on the rotor rotary shaft 7 so the auxiliary yoke 12 rotates with the rotor 1 and is housed inside the case 4.

Also, there is a round clamp 19 formed of a pair of non-magnetic bodies positioned along both sides of the axis around the periphery of the auxiliary yoke 12 on the inside of the auxiliary yoke support frame 18. There are thrust bearings 20 inserted between the round clamp 19 and the auxiliary yoke 12 so there is no displacement of the auxiliary yoke 12 along the axial direction on the rotor rotary shaft 7. With the auxiliary yoke 12 mounting structure, the auxiliary yoke 12 can be rotated synchronized with the rotor 1, which produces the following effects.

Basically, the rotating magnetic field generated by the stator 2 and the torque generating magnetic flux containing magnetic flux generated by the permanent magnets 6 (refer to FIG. 4) of the rotor 1 passes the auxiliary yoke 12. If as shown in FIG. 8, the structure is that of the auxiliary yoke 12 in the ready state, along with the changes in torque generating magnetic flux, there is excess current in the auxiliary yoke 12 due to rotation of the auxiliary yoke 12 synchronized with the rotating magnetic field, the structure of synchronized rotation of the auxiliary yoke 12 to the rotor 1 as shown in FIG. 9, inhibits the change in torque generating magnetic flux and controls generation of the excess current or loss of excess current.

If the auxiliary yoke 12 is restricted in the direction of the rotational axis such as that shown in FIG. 9, and the periphery of the auxiliary yoke 12 is restricted in the axial direction using a clamp 19 through a thrust bearing 20, it is possible to make the entire periphery and the entire diameter uniform in the space between the auxiliary yoke 12 and rotor 1. Also, the axial force β (refer to FIG. 3) can be stabilized to achieve the objective for the present invention.

Next is a description of the auxiliary yoke 12 mounting structure shown in FIG. 10. There is a round auxiliary yoke support frame 18 holding the rotor 1 and the stator 2. The bottom is attached to the case 4. The rotary shaft 7 of the rotor 1 penetrates both the stator 2 and the auxiliary yoke 12, and both ends of the axis support free rotation in the case 4 while each bearing 4 prevents displacement along the axis. Additionally, the center of the auxiliary yoke 12 fits into the spline 17b on the rotor rotary shaft 7 so the auxiliary yoke 12 rotates with the rotor 1 and is housed inside the case 4.

Also, there is a round clamp 21 formed of a pair of non-magnetic bodies positioned along both sides of the axis around almost the entire auxiliary yoke 12 on the inside of the auxiliary yoke support frame 18. There are thrust bearings 22 inserted between the round clamp 21 and the inside of the auxiliary yoke 12 so there is no displacement of the auxiliary yoke 12 along the axial direction on the rotor rotary shaft 7.

With the auxiliary yoke 12 mounting structure, the auxiliary yoke 12 can be rotated synchronized with the rotor 1 in the same manner as the auxiliary yoke mounting structure from FIG. 9. An effect identical to that in FIG. 9, specifically, the variation in torque generating magnetic flux can be restricted, which results in control of the excess current generated in the auxiliary yoke 12 as well as control of a loss in excess current.

If the auxiliary yoke 12 is restricted in the direction of the rotational axis such as that shown in FIG. 10, and the periphery of the auxiliary yoke 12 is restricted in the axial direction using a clamp 21 through a thrust bearing 22, the peripheral speed of the thrust bearing 22 will be reduced. This reduction may improve the durability of thrust bearing 22. Additionally, the thrust bearing 22 is compact, which has benefits from the perspectives of cost and weight.

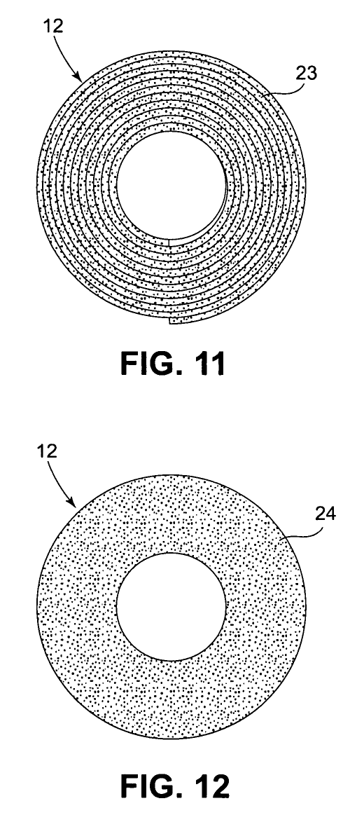

In this embodiment, the description was for an auxiliary yoke 12 as shown in FIG. 6 that is formed of a plurality of auxiliary yoke cores 16 that are arranged in the space in a circular direction around the magnetic disc shaped common auxiliary yoke back cores 17 for support. However, as shown in FIG. 11, instead of the auxiliary yoke 12, there can be a structure of an electromagnetic steel plate coil laminate formed of continuously winding an electromagnetic steel plate 23 around the center. Also, the structure can be a dust core 24 as shown in FIG. 12 and can achieve the same effects.

For the auxiliary yoke 12, the structure of a laminate of a coiled electromagnetic steel plate shown in FIG. 11 and the structure of a dust core 24 shown in FIG. 12 can have the following effects. If the auxiliary yoke 12 is secured as shown in FIG. 8, the variations in magnetic flux passing by the auxiliary yoke 12 in the ready state generates excess current in the auxiliary yoke 12 but an auxiliary yoke 12 with the electromagnetic steel plate 23 laminate shown in FIG. 11 makes it difficult for current to flow in the direction of the laminate (increased resistance) so it becomes difficult to generate excess current inside the auxiliary yoke 12. Additionally, as shown in FIG. 12, an auxiliary yoke 12 with the structure of a dust core 24 makes it difficult for current to flow in all directions (increased resistance) so it becomes difficult to generate excess current inside the auxiliary yoke 12. This reduces the loss of excess current inside the auxiliary yoke 12.

If the auxiliary yoke 12 is supported for rotation as shown in FIG. 9 and FIG. 10, the excitation of the stator 2 causes a rotating magnetic field and since there is a tendency for excess current to be generated in the auxiliary yoke 12, it becomes difficult to generate excess current in the auxiliary yoke 12 with the structure of the electromagnetic steel plate 23 laminate shown in FIG. 11 or the structure of the dust core 24 shown in FIG. 12, which is necessary to reduce the loss of excess current in the auxiliary yoke 12.

With an auxiliary yoke 12 with the structure of the electromagnetic steel plate 23 laminate shown in FIG. 11 or the structure of the dust core 24 shown in FIG. 12, the thickness of the auxiliary yoke 12 in the axial direction can be the same as the thickness of the stator back core 11 in the axial direction or thicker to obtain the following effects.

Basically, the number of magnetic flux lines determining the output of the motor is dependent on the minimum cross-section area of the magnetic flux path. The minimum cross-section area of the magnetic flux path for the rotor 2 and stator 2 is determined by the cross-section area of the direction of the magnetic flux path for the stator back core 11.

Thus, with an auxiliary yoke 12 with the structure of the electromagnetic steel plate 23 laminate shown in FIG. 11 or the structure of the dust core 24 shown in FIG. 12, if the thickness of the auxiliary yoke 12 in the axial direction is greater than the thickness of the stator back core 11 in the axial direction, the cross-section area of the magnetic flux path for the auxiliary yoke 12 is greater than the cross-section area of the magnetic flux path for the stator back core 11. Therefore, a reduction in motor output can be avoided without reducing the number of magnetic flux lines and the results can be achieved.

Various embodiments of the invention have been described. These and other embodiments are within the scope of the following claims.

1. An axial gap motor comprising:
a rotary shaft that rotates freely within a case;
a rotor comprising a plurality of permanent magnets connected to the rotary shaft;
a stator comprising a plurality of coils positioned facing a first side of the rotor, wherein the stator is disposed on the same axis as the rotary shaft; and
an auxiliary yoke disposed inside the case and positioned facing a second side of the rotor on the same axis as the rotary shaft, wherein:
the auxiliary yoke cannot be displaced in an axial direction, and
the auxiliary yoke comprises a magnetic body.

2. The axial gap motor of claim 1, wherein the auxiliary yoke is prevented from rotating within the case.

3. The axial gap motor of claim 1, wherein the auxiliary yoke further comprises:
a plurality of auxiliary yoke cores; and
a disc shaped auxiliary yoke back core supported by an arrangement of the plurality of auxiliary yoke cores in a circular direction.

4. The axial gap motor of claim 3, wherein the stator comprises a disc shaped stator back core supported by an arrangement of a plurality of stator cores wound around a coil in a circular direction, and wherein an auxiliary yoke back core thickness in the axial direction that is greater than a stator back core thickness in the axial direction.

5. The axial gap motor of claim 1, wherein the auxiliary yoke comprises one of an electromagnetic steel plate coiled laminate and a dust core.

6. The axial gap motor of claim 1, wherein the stator comprises a disc shaped stator back core supported by an arrangement of a plurality of stator cores wound around a coil in a circular direction, and wherein an auxiliary yoke thickness in the axial direction is greater than a stator back core thickness in the axial direction.

7. The axial gap motor of claim 1, wherein an auxiliary yoke diameter is greater than a rotor diameter.

8. A method comprising:
rotating a rotor between a stator and an auxiliary yoke, wherein the rotor is attached to a freely rotating rotary shaft and the stator and auxiliary yoke are fixed within the case; and
generating torque at the rotary shaft via a magnetic flux between the rotor, stator, and auxiliary yoke.

9. The method of claim 8, further comprising:
producing an axial force α that acts towards the stator; and
producing an axial force β that acts towards the auxiliary yoke.

10. The method of claim 9, wherein the axial force α less than 20 percent greater than axial force β.

11. The method of claim 9, wherein the axial force β is less than 20 percent greater than axial force α.

12. The method of claim 9, wherein the axial force α is approximately equal to the axial force β.

13. An axial gap motor comprising:
means for rotating a rotor freely within a case;
means for generating torque via a magnetic flux; and
means for reducing an axial force between the generating means.

14. The axial gap motor of claim 13, wherein the means for reducing the axial force is prevented from rotating within the case.

15. The axial gap motor of claim 13, wherein the means for reducing the axial force comprises:
a plurality of auxiliary yoke cores; and
a disc shaped auxiliary yoke back core supported by an arrangement of the plurality of auxiliary yoke cores in a circular direction.

16. The axial gap motor of claim 15, wherein the means for generating torque comprises a disc shaped stator back core supported by an arrangement of a plurality of stator cores wound around a coil in a circular direction, and wherein an auxiliary yoke back core thickness in an axial direction that is greater than a stator back core thickness in the axial direction.

17. The axial gap motor of claim 13, wherein the means for reducing the axial force comprises one of an electromagnetic steel plate coiled laminate and a dust core.

18. The axial gap motor of claim 13, wherein the means for generating torque comprises a disc shaped stator back core supported by an arrangement of a plurality of stator cores wound around a coil in a circular direction, and wherein a thickness of the means for reducing the axial force in the axial direction is greater than a stator back core thickness in the axial direction.

19. The axial gap motor of claim 13, wherein a diameter of the means for reducing the axial force is greater than a rotor diameter.
